(19) United States
(12) Patent Application Publication
(10) Pub. No.: US 2005/0021830 A1
(43) Pub. Date: Jan. 27, 2005

(54) Data communications method and system using buffer size to calculate transmission rate for congestion control

(76) Inventors: Eduardo Urzaiz, Suffolk (GB); Mathew D Walker, Suffolk (GB)

Correspondence Address: NIXON & VANDERHYE, PC, 1100 N GLEBE ROAD, 8TH FLOOR, ARLINGTON, VA, 22201-4714, US

(21) Appl. No.: 10/488,345

(22) PCT Filed: Sep. 13, 2002
(86) PCT No.: PCT/GB02/04182

(30) Foreign Application Priority Data
Sep. 21, 2001 (EP) 013080536

(51) Int. Cl. G06F 15/16

(52) U.S. Cl. 709/234; 709/233

(57) ABSTRACT

A data transmission method and system is disclosed in which one or more data streams are transmitted at respective transmission rates which are controlled to prevent data buffers in the receiver from overflowing. In some embodiments feedback data concerning the state of each buffer in a receiving client is received at the transmitting server, and used to adapt the sending rates to achieve the effect. Information indicative of the data decode rates or the fill extent of each buffer is communicated to the server as the feedback data. In other embodiments the server makes an open-loop estimate of the remaining space in the buffer, and controls the transmission rate accordingly. A data receiving method and system adapted to receive the data streams is also disclosed.

### TECHNICAL FIELD

The present invention relates to a method and system providing for data communications, and in particular to a method and system for transmitting one or more data streams across a network, as well as a method and system for receiving such transmitted data. Furthermore, the present invention also relates to a computer readable storage medium storing a computer program which when run on a computer controls the computer to perform the aforementioned methods of data transmission and receipt.

### BACKGROUND TO THE INVENTION

In recent years there has been a tremendous increase in the number, extent, and number of users of telecommunications networks for data communications. Previously, it was a characteristic of much of the data traffic carried on such telecommunications networks that the data was substantially “message-based”. By “message-based” we mean that the data transmitted on a network formed part of, for example, e-mail messages, files in the process of being transferred, or other application data being passed between client-server systems. A principal characteristic of such “message-based” data is that it is not particularly time critical that the data must arrive at the receiver terminal within a certain time of transmission for it to be of any use. Rather, provided the data arrives at the receiver within a reasonable amount of time then it is still of use to the eventual user. Previously known examples of such “message-based” data are for example standard e-mails and files transferred using the file transfer protocol (FTP).

More recently, interest has turned away from the capability of data communications networks in sending traditional message-based data towards the network and associated equipment being able to transmit data in a continuous data stream from a transmitter to a receiver. Frequently the value of such data is time critical in that the network must transport the data from the transmitter to the receiver terminal as smoothly and quickly as possible, preferably avoiding the need for data to be re-sent. An example of such a data streaming system known in the prior art is described next with respect to FIG. 1.

Commonly, the data to be streamed is multi-media data such as, for example, audio and video data. The audio and video data may be from a live audio visual broadcast such as a news or sports event, or may be sourced from, for example, a video-on-demand service which permits subscribers to watch television programmes and films of their choice as and when they choose. Whatever the source of the data, however, the respective audio and video feed data must first be suitably digitally encoded in order to compress the audio and video data signals to a size suitable for transmission over a network. Commonly, audio and video encoding is performed in accordance with one of the various MPEG standards.

Following encoding of the audio and video data, the encoded data is passed to a network server, where it is stored in separate audio and video buffers prior to transmission over the network to a client.

Following buffering, the data is transmitted over the network as discussed in more detail next, and is received at the receiver wherein it is buffered prior to decoding. Decoding is performed at the receiver by an appropriate decoder, and the decoded data sent to the application running at the receiver for reproduction.

One of the most common types of network presently in use is of course those which form the internet, and which use internet protocol (IP) to transfer data in the form of IP datagrams in the network layer of the network. Data transport over the network layer is provided by the transport layer protocols transmission control protocol (TCP) and user datagram protocol (UDP). Both TCP and UDP are known in the art, and are described in, for example, Tannenbaum A. S., “Computer Networks” Third Edition, Prentice Hall, PP521-542.

Frequently UDP has been used for streaming data services over a network, and especially for streaming audio and video data. However, UDP is a connectionless transport protocol and therefore offers no quality of service control mechanisms nor the ability to permit a particular quality of service to be guaranteed to a user. Furthermore, the use of UDP for streaming data causes further problems in that as it always sends out data at the same transmission rate it makes no consideration for either the network congestion state, or the state of the received data buffers at the receiving terminal, which can easily result in packet losses and hence lost data. That is, when using UDP for data streaming then in the event that network congestion occurs UDP continues to transmit data packets at the same transmission rate thereby contributing to the network congestion. In the worst case with no mechanism by which to alleviate the network congestion the result can be that many or all of the packets of the data stream are lost. Similarly, in the event that the data transmission rate of the stream is higher than the rate at which the receiver buffers are emptied, then the buffers can overflow, thereby providing another mechanism for packet loss. The deleterious effects in such a case are double-edged—not only has the receiver lost the overflow data which, in the case of real-time multimedia data will result in poorer quality reproduction, but the network has wasted bandwidth in transmitting overflow packets which were then lost at their destination.

The problems described above associated with the use of UDP for data streaming can be alleviated slightly by using TCP as the network transport protocol. TCP is a connection-oriented protocol that provides packet acknowledgements to the sending terminal which permits an increased amount of control over the transmission rate of the data. More particularly, TCP incorporates a transmission rate control algorithm to account for network congestion, as described in ibid, page 536 to 539. The TCP transmission control algorithm is of the type known as “additive-increase-multiplicative-decrease”, wherein once a basic threshold transmission rate is reached, the transmission rate is then increased in an additive manner packet by packet until a packet loss occurs, whereupon the transmission rate is then decreased in a multiplicative manner, e.g. by dividing the transmission rate in half. The TCP transmission rate algorithm therefore takes into account network congestion by reducing the transmission rate of a data stream when a packet loss occurs, but the multiplicative nature of the decrease means that the change in data throughput over the network can be quite high.

FIG. 2 illustrates an example data throughput using TCP whence it will be seen that the data transmission rate can vary considerably with respect to time. The relatively high variance in transmission rate using TCP means that it is not particularly suited to data streaming applications, where a steady state transmission rate which changes smoothly with respect to time is preferable. Furthermore, the TCP transmission rate control algorithm pays no regards to the receiver buffer state, thereby again introducing the possibility of packet loss if the TCP stream transmission rate should be higher than the decode rate at the receiver. As with the case of UDP, the loss of a packet at the destination presents double-edged deleterious effects—not only has the receiver lost the overflow data which, in the case of real-time multimedia data will result in poorer quality reproduction, but the network has wasted bandwidth in transmitting overflow packets which were then lost at their destination.

The problems associated with the frequent changes in data transmission rate using TCP for streaming data are further compounded when two or more data streams which contain related data, such as, for example, audio and video data, are to be transmitted simultaneously. In this case, when using TCP and taking the transmission of audio and video data in separate data streams as an example, because the audio stream is transmitted over a separate TCP connection from the video stream then each respective connection will apply its own transmission rate control algorithm without any regard to the transmission rate of the other stream. This has the resulting effect that over time the data throughput of the audio stream over the network becomes substantially the same as that of the video stream, whereas in reality for most audio visual sources there is commonly much more video data to be transmitted per unit time than audio data. This equality in transmission rate between the audio and video streams thus achieved by TCP can have the effect at the receiver of affecting proper reproduction of the data, in that because the two types of data are not transmitted at respective rates which match the ratio of the generation of audio and video data, there will commonly be sufficient audio data stored in the receiver audio buffer for reproduction by the audio visual application, but insufficient video data in the receiver video buffer for reproduction at the same time as the audio data.

Further problems arise from the separate application of the transmission rate control algorithm to each respective stream, and in particular from the multiplicative decrease nature of the standard TCP transmission rate control algorithm. Consider the case where an audio stream is being transmitted over a TCP connection separately to a video stream, which is also being transmitted using TCP. Usually, as explained previously, the average throughput of each connection would be substantially the same, but due to the multiplicative decrease in transmission rate when a packet loss on one of the streams occurs, at any particular moment in time there can in fact be large differences in the respective transmission rates of the two streams. These potentially large short term variations in transmission rate between the two streams introduce uncertainties into the data transmission, and can cause problems with the data buffers in the receiver, in that where temporary large differences occur, the audio buffer, for example, might fill and overflow thereby losing data, whereas the corresponding video buffer may have emptied therefore preventing AV reproduction from taking place.

The above mentioned problems as caused by the application of the TCP transmission rate control algorithm to multiple data streams have been addressed previously by using the connectionless UDP protocol for each stream, and simply transmitting each stream at the appropriate transfer rate to maintain the correct ratio of data between the stream. However, as discussed previously UDP makes no provision for controlling the transmission rates to take into account the state of the receiver buffers. Therefore there is still a need for a transmission rate control method and system which can maintain both the stability of the transmission rate of each stream, while still taking into account the state of the buffers in the receiver in order to prevent unnecessary packet loss at the receiver.

### SUMMARY OF THE INVENTION

The present invention addresses the aforementioned problems by providing a method and system of data transmission wherein a network server determines the state of the receiver buffer. The server then transmits the data stream at a data transmission bit rate, controlling the data transmission rate of the stream such that the receiver buffers are prevented from overflowing. The control of the transmission rate also has the effect of providing for a smooth steady state transmission rate for the data stream. The determination of the receiver buffer state can be performed in an open- or closed-loop manner.

In view of the above, from a first aspect according to the present invention there is provided a method of data transmission across a network, comprising the steps of:
transmitting data onto the network for transmission to a receiver in the form of a data stream at a data transmission rate;
determining at least one or more characteristics of a data buffer in the receiver in which the received data is stored; and
controlling the data transmission rate of the data stream in response to the determined characteristics in order to prevent the data buffer in the receiver from overflowing.

From a second aspect, the present invention also provides a system for data transmission across a network, comprising:
data stream transmission means for transmitting data onto the network for transmission to a receiver in a data stream at a data transmission bit rate;
characteristic determination means for determining at least one or more characteristics of a data buffer in the receiver in which the received data is stored; and
data stream controlling means for controlling the data transmission rate of the data stream in response to the determined characteristics in order to prevent the data buffer in the receiver from overflowing.

By determining the one or more characteristics of the data buffer in the receiver in which the received data in the stream is stored, the present invention allows the data transmission rate to be controlled in such a manner such that packets are not lost at the receiver due to buffer overflow. This provides the advantage that network bandwidth utilisation is improved, as in the case where any lost data packets are resent there should be no need for resends as the data should not be lost through buffer overflow in the first place. Furthermore, in the case of, for example, real-time data where no data resend is usually necessary, the real-time data reproduction can be rendered in a smoother fashion, and with the intended reproduction quality.

The characteristic determination may be open-loop or closed-loop. In particular, when the determination is open-loop the server merely keeps track of how many packets it has sent to the receiver, and what the decode-rate of those packets will be. By then knowing the receiver buffer size in advance the server can maintain an estimate of how much space is left in the receiver buffer, and adjust the transmission rate accordingly.

Where the characteristic determination is closed-loop, the receiver transmits information indicative of the one or more characteristics to the server, and the server then uses the received information as the basis of the transmission rate control.

Preferably the one or more characteristics include at least the decoding rate of the transmitted data in the stream at the receiver, and the transmission rate of the data stream is further controlled as a function of a least the receiver decoding rate. By linking the transmission rate of the data stream to the decoding rate it is possible to achieve a stable steady state transmission from the transmitter to the receiver which is particularly suitable for streaming real-time data.

In other embodiments, the one or more characteristics of the data buffer include information indicative of the remaining capacity of the buffer. By determining the remaining buffer capacity, it becomes possible to effect either continuous or step changes in the transmission rate as appropriate, for example by changing the transmitted data to data which has been encoded with a lower quality, therefore requiring less buffer capacity to reproduce the same information.

In other preferred embodiments, the method further comprises the step of calculating the maximum transmission rate at which the data stream should be transmitted, and the transmission bit rate is controlled so as to be within the calculated maximum rate.

By calculating a maximum transmission rate for the stream using a transmission rate formula which has been derived to take into account network congestion, it is possible to control the maximum transmission rate of the stream in order to account for congestion in those parts of the network to which the stream is routed thereby minimising the impact of yet another packet loss mechanism.

Preferably the maximum transmission rate is calculated to give an average data throughput over the network similar to that obtained using transport control protocol (TCP), such that the data stream could be said to be “TCP-friendly”. By using a transmission rate control scheme which is TCP friendly advantages are obtained that the transmission rate can be controlled to account for network congestion, as well as accommodating other competing TCP connections within the network.

Preferably, the method further comprises the steps of transmitting a plurality of data streams onto the network for transmission to the receiver, each at a respective data transmission rate; determining at least the one or more characteristics of the respective data buffers in which the received data streams are stored; and controlling the respective transmission rate of each stream in response to the received feedback data in order to prevent the data buffers from overflowing.

In accordance with the above, the present invention also has application in the transmission of multiple data streams from a transmitter to one or more receivers which may be the same or different.

Preferably, the transmitted data stream contains audio or video data. Where two data streams are transmitted simultaneously, preferably one of the streams contains audio data and the other of the streams contains video data. Preferably the audio aid video data is related in teat it is intended for reproduction at the receiver simultaneously, for example where the video data is a TV programme or film and the audio data is the soundtrack thereto. The invention is particularly intended for the transmission of audio and video data in streams, where the sending rate of each stream can be controlled by the invention so as to be substantially smooth, and so as to prevent the receiver buffers from overflowing. Preferably, the sending rate is controlled so as to match the read-out rate from the receiver buffers.

Preferably, the invention is further arranged to receive feedback data from the or each receiver indicative of one or more of a round trip time (RTT), a loss rate value, and/or a receiving rate value at the receiver, and furthermore to calculate the total transmission rate as a function of one or more of the received values indicated by the feedback data. The round trip time is a measure of the it takes for data to travel from a transmitter to the receiver and back to the transmitter, whereas the loss rate value is a measure of the amount of data transmitted to the receiver which is lost in the network. The receiving rate value is the number of bits received by the receiver in the round trip time.

By providing feedback from the receiver to the server it is possible to provide the server with up to date information indicative of, for example, congestion conditions on the network resulting in packet losses. The server then becomes capable of calculating the maximum transmission rate available for the stream dependent upon the present conditions on the network, thereby optimising the transmission rate at which the stream is transmitted.

Furthermore, from a third aspect the present invention further provides a computer readable storage medium storing a computer program which when run on a computer controls the computer to perform a method according to the first aspect of the invention.

Preferably, the computer readable storage medium is any of an optical disk, a magnetic disk, a magneto-optical disk, a solid state computer memory, or any other suitable data storage medium.

From a fourth aspect, the present invention also provides a method of receiving data from a network, the data having been transmitted according to a method or system as previously described in respect of the first or second aspects of the invention, the method comprising the steps of:
receiving a data stream at a data transmission rate;
passing the received data to a data buffer for buffering therein;
measuring at least one or more characteristics of the data buffer; and
transmitting the measured characteristics to a transmitter for use in calculating the transmission rate of the data stream transmitted therefrom.

By transmitting the characteristics of the data buffer back to the transmitter it becomes possible for the transmitter to control its data transmission rate to prevent the data buffer in the receiver from overflowing, and data being lost.

Preferably, in the fourth aspect the method further comprises the step of decoding the data in the data buffer at a decoding rate, and transmitting the data decoding rate to the receiver as at least one of the measured characteristics. By communicating the data decoding rate to the transmitter, it becomes possible for the transmitter to control its transmission rate in order to achieve a stable steady state transmission rate wherein the decoding rate is substantially matched to the transmission rate, preferably accounting for packet loss in the network.

Furthermore, preferably the one or more characteristics further include information indicative of the remaining capacity of the buffer. By communicating this information to the transmitter, the transmitter can further control the transmission rate of the data stream using step changes in the rate as an emergency measure to prevent buffer overflow.

From a fifth aspect the present invention also provides a system for receiving data from a network, data having been transmitted according to a method or system of the first or second aspects of the invention. In the fifth aspect, the system comprises:
data receiving means for receiving a data stream at a data transmission rate;
data bus means for passing received data to a data buffer for buffering therein;
buffer monitoring means for measuring at least one or more characteristics of the data buffer; and
data transmission means for transmitting the measured characteristics to a transmitter for use in calculating the transmission rate of the data stream transmitted therefrom.

The fifth aspect of the invention presents the same features and advantages and further features and advantages as previously described in respect of the fourth aspect.

Furthermore, from a sixth aspect the present invention also provides a computer readable storage medium storing a computer program which when run on a computer it controls the computer to perform the method according to the fourth aspect of the invention. As in the third aspect, the invention according to the sixth aspect may be embodied in any one or more of a magnetic disk, an optical disk, a magneto-optical disk, a solid state computer memory, or the like.

### BRIEF DESCRIPTION OF THE DRAWINGS

Further features and advantages of the present invention will become apparent from the following descriptions of embodiments thereof, presented by way of example only, and by reference to the accompanying drawings, wherein like reference numerals refer to like parts, and wherein:

FIG. 1 is an illustrative block diagram illustrating the elements of a multimedia streaming system of the prior art;

FIG. 2 is a graph illustrating data throughput of a network using the prior art TCP protocol;

FIG. 3 is a block diagram illustrating the arrangement of a server and a client apparatus used in the embodiments of the present invention;

FIG. 4 is a block diagram of the main elements of a server apparatus for use in the embodiments of the present invention;

FIG. 5 is a block diagram of the functional elements used in a client apparatus for use in the embodiments of the present invention;

FIG. 6 is a flow diagram of the method steps performed by a server apparatus in a first embodiment of the present invention;

FIG. 7 is a flow diagram of the method steps performed by a client apparatus used in the first embodiment of the present invention;

FIG. 8 is a flow diagram illustrating the steps involved in the calculation of the loss event rate used in the embodiments of the invention;

FIG. 9 is a graph of filter coefficients used in the embodiments of the invention;

FIG. 10 is a block diagram of the filter elements used in the receiver apparatus in the embodiments of the invention;

FIG. 11 is a flow diagram of the method steps performed by a server apparatus in a second embodiment of the present invention;

FIG. 12 is a flow diagram of the method steps performed by a client apparatus used in the second embodiment of the present invention; and

FIG. 13 is a graph of data throughput across a network for one of the data streams achieved using the embodiments of the invention.

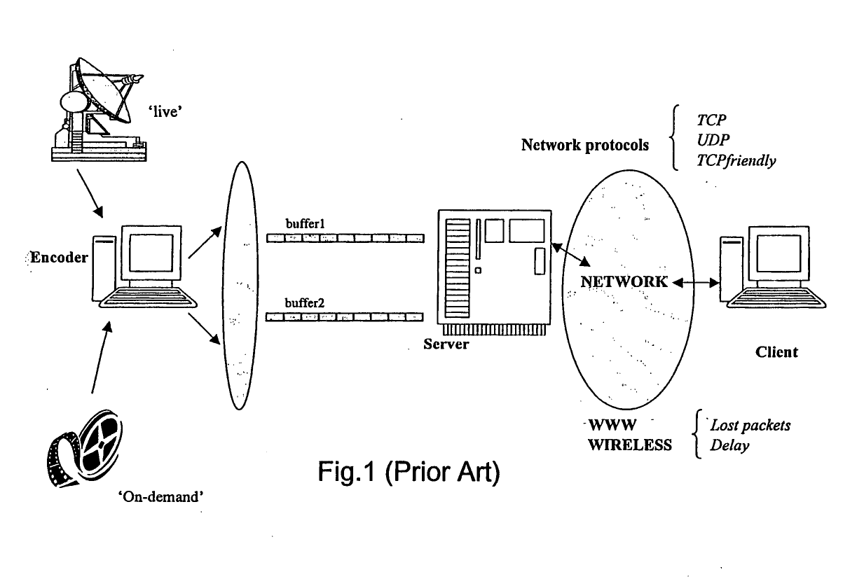

### DESCRIPTION OF THE PREFERRED EMBODIMENTS

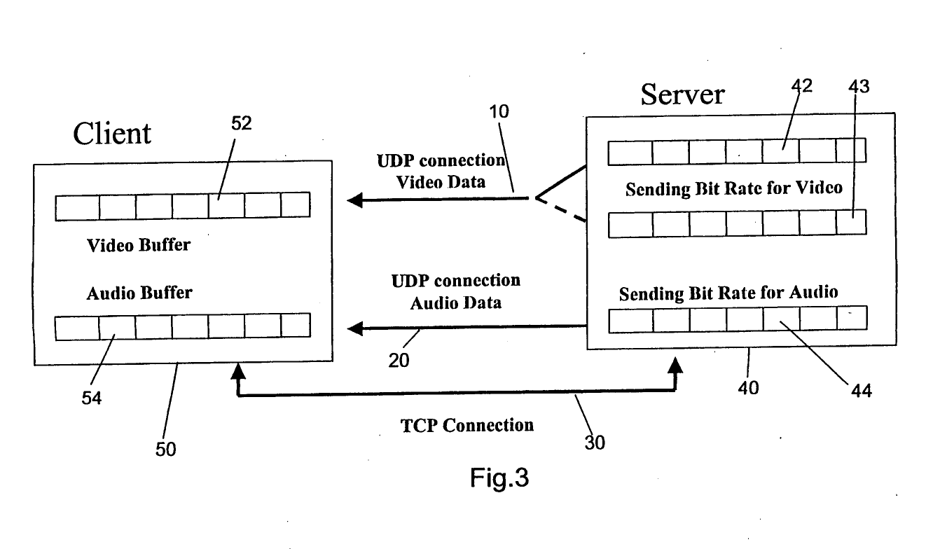

The construction and operation of the various elements which constitute three embodiments of the present invention will now be described with reference to FIGS. 3-13. It should be noted that the preferred embodiments described herein are intended as non-limiting example of the application of the present invention to the transmission of multimedia data such as audio and video data, but that the present invention may find use in almost any application where one or more streams of data are to be transmitted over a network.

Within the description the terms “transmitter” and “server” are used interchangeably, as are the terms “receiver” and “client”.

Each of the embodiments of the invention to be described herein may utilise the same system elements, although to differing degrees, and with differences in their methods of operation. As a consequence there follows a common description of the apparatus which may be used in each of the embodiments, followed by separate descriptions of the operation of each of the embodiments in turn.

The two basic elements which form the system of the preferred embodiments of the present invention are depicted in FIG. 3. Here, it will be seen that a server 40 is provided which has provided therein a first video buffer 42 and a second video buffer 43. The first video buffer 42 is arranged to store encoded video data which has been coded at a first video encoding rate, whereas the second video buffer 43 is arranged to store more encoded video data which has been encoded at a second, lower encoding rate than the encoded video data stored in the first buffer 42. It should be noted that the encoded video data stored in the two buffers 42 and 43 is derived from the same original video data, but that it has merely been encoded using different encoding rates to give the different encoded video data. Typically, due to the higher encoding rate used to generate the encoded video data stored in the first buffer 42, the encoded video data in the first buffer 42 will be of a greater size than the corresponding encoded video data encoded at the lower encoding rate stored in the second video buffer 43. Preferably the video data is encoded using H.623 encoding, although it should be understood that any suitable video encoding technique could be used, such as MPEG or the like.

Also provided within the server 40 is an audio data buffer 44 which is provided to store encoded audio data. Please note that in the preferred embodiments audio data is only encoded at a single encoding rate, and hence there is only the requirement for a single audio buffer. Preferably the audio data is encoded using AMR audio encoding, although any other suitable audio encoding techniques such as MP3 or the like may be used.

As well as the server 40, in the preferred embodiments one or more client computers 50 are also provided. FIG. 3 shows a single client for the sake of clarity, but it is possible for the server to service more than one client, and for more than one data stream to be transmitted to each client. In the embodiments, each client comprises a video buffer 52 and an audio buffer 54. The video buffer 52 is arranged to receive and store encoded video data which is received from the server 40. The video buffer 52 stores the received encoded video data until a video decoder provided in the client computer retrieves the encoded video data therefrom for decoding and reproduction of the video signal encoded therein. Similarly, the audio buffer 54 receives encoded audio data transmitted from the server 40, buffers the encoded audio data until such time as an audio decoder provided in the client computer retrieves the encoded audio data therefrom for decoding and reproduction of the audio signal encoded therein.

In order to provide for data communications between the server computer and the or each client computer a first user datagram protocol (UDP) connection 10 is provided between the server 40 and the or each client 50 along which encoded video data is transmitted from the server 40. Similarly, a second UDP connection 20 is also provided from the server 40 to the or each client 50 along which encoded audio data is transmitted. The transmission rates of the respective UDP connections 10 and 20 are controlled by the server in a manner to be described later for each embodiment of the invention.

In addition to the UDP connections between the server and the or each client, in the first and second embodiments a transport control protocol (TCP) connection 30 is established between the or each client and the server in order to provide for the transmission of control messages principally from the or each client back to the server in order to allow for effective control of the transmission rate of the two UDP connections 10 and 20. Further details of the feedback data transmitted from the or each client to the server over the TCP connection in each embodiment will be discussed later.

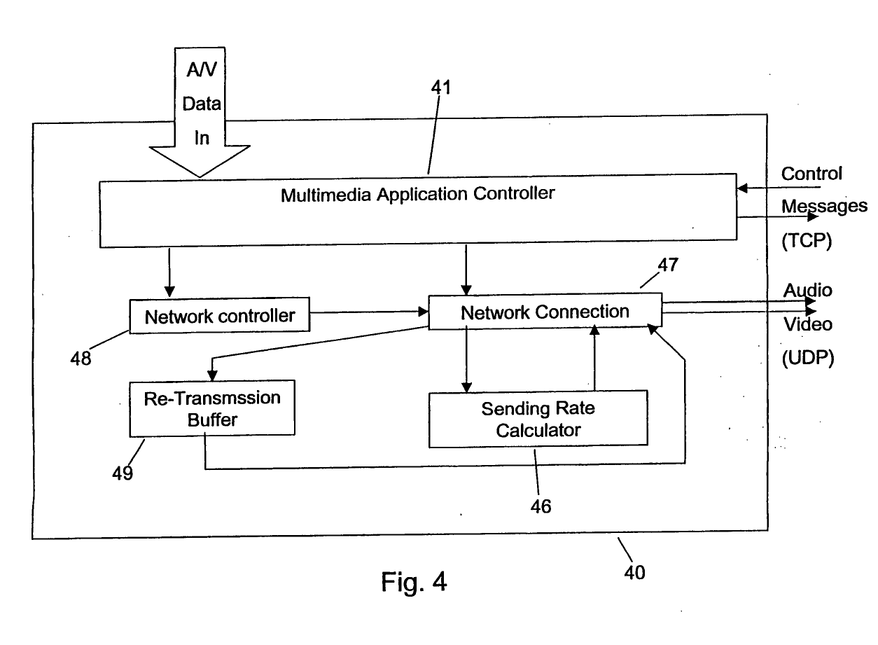

Turning now to FIG. 4, FIG. 4 illustrates in block diagram form the elements required within the preferred embodiments of the invention within the server computer 40. It should be noted that FIG. 4 illustrates only those components of the server which are necessary for the operation of at least one of the embodiments of the present invention, and does not illustrate those other elements of a server system which are necessary for operation, it being understood that the intended reader being a man skilled in the art will recognise which additional elements of a server system are required for full operation.

In the preferred embodiments, the server computer 40 comprises a multimedia application controller 41 which is arranged to received encoded audio data and encoded video data and to buffer the received data therein in the buffers 42, 43 and 44 as previously described with respect to FIG. 3. Please note that these buffers are not shown on FIG. 4 for the sake of clarity. The multimedia application controller 41 sends and receives control messages via the TCP connection 30 to and from the client computer 50. Furthermore, the multimedia application controller provides encoded video data and encoded audio data from the appropriate buffers to the network connection module 47 which packetises the data for transmission across a network to the client computer. Therefore, the network connection module 47 operates to receive the encoded audio and video data from the multimedia application controller, packetises the data into a form suitable for transmission, and transmits the data packets on to the network in two respect UDP data streams at appropriate respective sending rates. The respective sending rates of the data streams are calculated by a sending rate calculator 46 in accordance with a suitable transmission rate formula which is discussed later for each embodiment. The sending rate calculator 46 passes the calculated sending rates for the audio and video data streams to the network connection module 47 in order to inform the network connection module 47 of the calculated transmission rates. In the first and second embodiments the input data to the transmission rate formula calculated in the sending rate calculator 46 is obtained over the TCP connection from the client computer to the multimedia application controller, from where it is passed to the sending rate calculator via a suitable connection.

A network controller module 48 is further provided in order to control the network connection 47 to perform appropriate data packetisation procedures in order to permit the audio and video data to be transmitted on to the network.

Furthermore, a retransmission buffer 49 being a memory or the like is further provided arranged to receive data packets from the network connection 47 together with appropriate control signals, and to buffer the received data packets therein in the event that the network connection 47 has to retransmit the buffered packets. The buffering and retransmission of sent data packets is not relevant to the present invention, and hence no further details will be elucidated herein.

Although not shown in FIG. 4, it should further be noted that the server computer 40 further includes at least one computer-readable storage medium which stores a computer program which controls the operation of the server computer to perform the invention. The computer-readable storage medium may be of any known type, and in particular may be formed from any one of or a combination of an optical disk, a magnetic disk, a magneto-optical disk, a solid state computer memory, or any other suitable data storage medium.

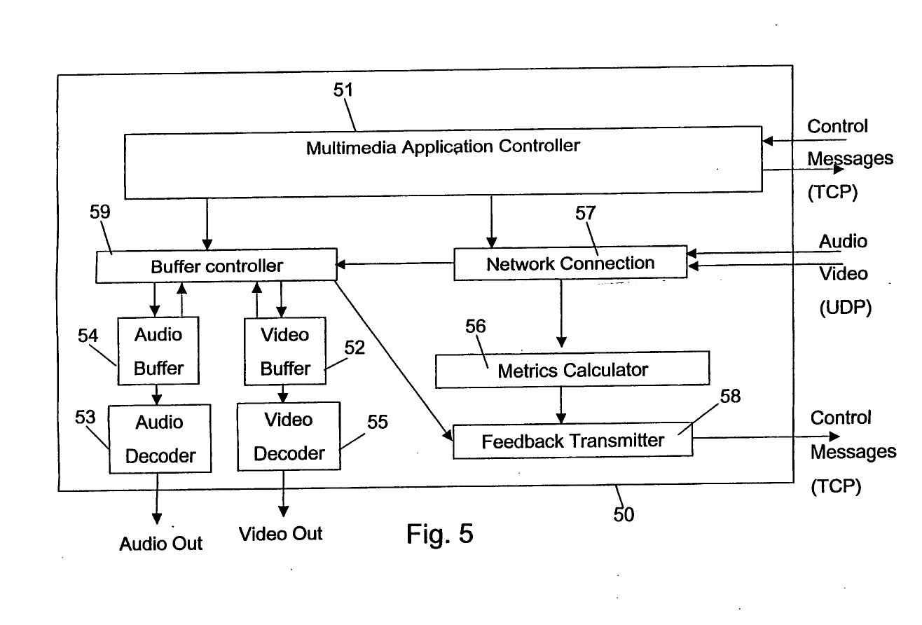

FIG. 5 is a block diagram of the functional elements of the client computer 50 required in the embodiments of the invention. As with the server computer 40, it should be understood that FIG. 5 does not illustrate all of the necessary components of the client computer 50 for operation, but only those functional block elements which are required for the operation of at least one of the preferred embodiments of the present invention. The intended reader being a man skilled in the art should understand which additional components of the client computer are required for full operation.

Within the client computer 50 a multimedia application controller 51 is provided which corresponds to the multimedia application controller 41 provided in the server. The multimedia application controller 51 provides high level control of the multimedia application running in the client computer 50, and communicates with the corresponding multimedia application controller 41 in the server via control messages passed over the TCP connection 30. Similarly, the multimedia application controller 51 provides control signals to the other functional elements of the client computer 50 which constitute the preferred embodiment.

Further provided within the client computer 50 is a network connection module 57 which is arranged to receive data packets from the network in one or more data streams. Control information concerning the received data in the one or more data streams is passed to a metrics calculator 56 for calculation of quantitative values indicative of certain characteristics of the received data streams, and the calculated quantitative values are passed to a feedback transmitter 58 for transmission back over the network as control messages over the TCP connection 30. Further information on the calculation of the quantitative values is given later.

The network connection 57 receives the audio and video data streams, and retrieves the encoded audio and video data from the packets in each stream. The encoded audio and video data is then passed to a buffer controller 59 which feeds the received encoded audio data into the audio buffer 54, and the received encoded video data into the video buffer 52. The buffer controller 59 is further arranged to monitor the state of the audio buffer 54 and the video buffer 52 to determine how full each buffer is, and the rate at which each buffer empties, which is indicative of the decoding rate of the data stored therein. An audio decoder 53 is further provided which reads encoded audio data from the audio buffer 54, and decodes the encoded audio data to provide decoded audio data as an output. Similarly, a video decoder 55 is provided which takes encoded video data from the video buffer 52, and decodes the encoded video data to provide a video output signal.

The buffer controller 59, upon receipt of the information concerning the state of the audio and video buffers passes this information to the feedback transmitter for incorporation into the control messages passed back to the server computer over the TCP connection 30.

Although not shown in FIG. 5, it should be noted that the client computer further includes at least one computer-readable storage medium which stores a computer program which controls the operation of the client computer to perform the invention. The computer-readable storage medium may be of any known type, and in particular may be formed from any one of or a combination of an optical disk, a magnetic disk, a magneto-optical disk, a solid state computer memory, or any other suitable data storage medium.

Having described the basic functional blocks forming the server apparatus and client computer apparatus of the present invention, a description of the operation of the preferred embodiments of the invention will now be described in turn.

First Embodiment

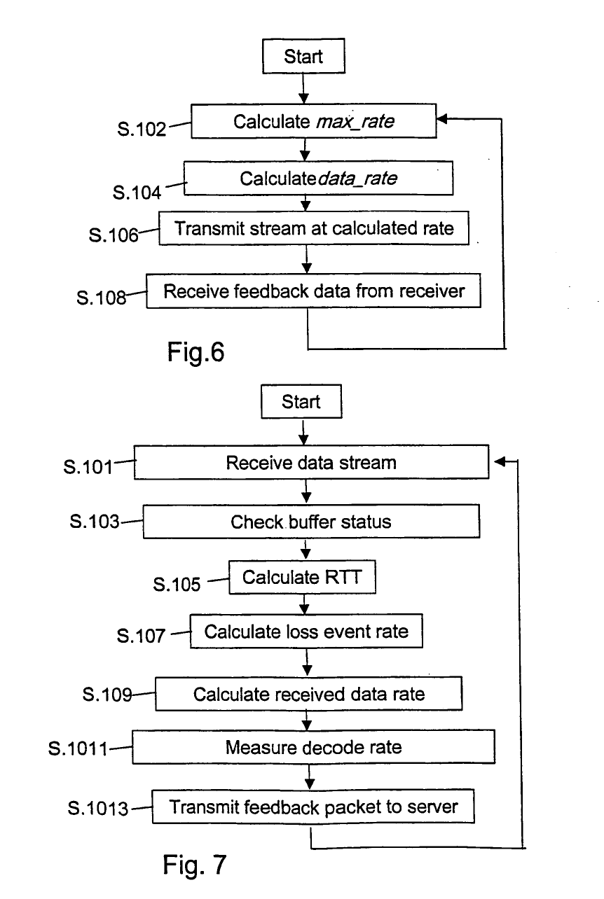

A first embodiment of the present invention will now be described with respect to FIGS. 6 to 10. The first embodiment is particularly concerned with sending one or more independent streams to the same or different clients, and controlling the transmission rate of the stream in a closed-loop manner.

FIG. 6 is a flow diagram of the steps performed by the server computer 40 in accordance with the first embodiment of the present invention. Firstly, at step 102 the sending rate calculator 46 calculates the total bandwidth available for the individual data streams which are to be transmitted from the server computer 40. This value max_rate represents the upper limit on transmission rate which the transmission rates of each separate data stream should not be exceed. The value max_rate is calculated in accordance with the following principles.

Typically, previous multimedia conferencing applications presently used in the Internet are based on the UDP transport protocol, which as previously discussed offers no quality of service control mechanisms and is therefore incapable of performing control actions such as are required to compensate for, for example, network congestion. Thus, when network congestion occurs competing TCP connections reduce their transmission rates as described previously without any rate reduction on behalf of UDP traffic.

In order to get around this problem, in the first embodiment of the present invention the UDP audio and video data streams are enhanced with a congestion control scheme of which the calculation of a max_rate parameter forms a part. More particularly, the parameter max_rate is calculated to provide a maximum transmission rate for a stream which is “TCP-friendly”, being a transmission rate which over time is analogous to the throughput achieved via a TCP connection.

In the first embodiment, the total transmission rate parameter max_rate is calculated using a transmission rate formula which has been derived so as to model the average throughput over time of a TCP connection, and therefore total rate is calculated so as to provide a TCP-friendly transmission rate. In the first embodiment we use the transmission rate formula illustrated in equation 1 below

$$bit\_rate \_stream = c ( \frac{packet\_medium \_size}{R T T \sqrt{loss\_rate}} ) \qquad Eq . 1$$

Please note that the derivation for the above equation applied to an ubiquitous TCP connection can be found in Floyd S. “Connections with Multiple Congested Gateways in Packet Switched Networks Part 1: One Way Traffic”, Computer Communications Review, volume 21, number 5, October 1991, page 30-47.

In the above equation C is a constant in the range of 0.87 to 1.31, RTT is the round trip time in seconds being a measure of the time it takes for a packet to transfer from a computer, across a network to another computer, and back, loss_rate is a measurement of packets lost in the network en route to the receiver, and packet_medium_size is the average size of the packets to be transmitted in the stream for which the calculation is being performed. Please note that further discussion of these elements of equation 1 and how they are calculated for use in the transmission rate formula is undertaken later.

Equation 1 gives a value bit_rate_stream which is an estimate of the average bandwidth that a single TCP connection would achieve in the present network conditions. However, in the first embodiment we do not use this estimate directly as the total transmission rate for a stream, but rather this value bit_rate_stream is placed into equation 2 as set out below:
max_rate=min(bit_rate_stream,2*receiving_rate_stream) Eq. 2

The parameter receiving rate stream is received from the or each client computer over the TCP connection, and corresponds to the number of bits received by the client for the particular stream for which the calculation is being made in RTT seconds.

The above equation 2 gives the total bandwidth max_rate available for a single UDP stream to give TCP-friendly performance. This value is the maximum value at which the data stream should be transmitted in order to remain TCP-friendly. It should be noted that the calculations of equations 1 and 2 should be performed separately for each stream which the server is transmitting.

Following the calculation of the available maximum transmission rate, at step S104 the sending rate calculator 46 in the server calculates the actual transmission rate (data_rate) for the or each data stream, which could be either the audio UDP stream or the video UDP stream. The value of data_rate is calculated as follows.

As mentioned previously, the main thrust of the present invention is to control the transmission rate of one or more data streams such that the level of data in the data buffers in the receiver can be controlled to prevent the one or more respective buffers at the or each client from overflowing. In the first embodiment the transmission rate of each data stream transmitted from the server is controlled independently from that of other streams transmitted from the server to the same or different clients, the control being effected in response to feedback data from the or each client concerning the state of the data buffers in which the received data is stored prior to decoding. Within the first embodiment it is envisaged that the or each client computer can report back at least one or more of the data decoding rate (equivalent to the rate at the which the buffers are emptied), or information indicative of how full (or alternatively how empty) each buffer is. Using this information the sending rate calculator 46 is able to calculate the data_rate value for each stream in accordance with any one or more of the following variants.

In a first variation, the server receives feedback data from the client corresponding to the decode rate at the client of received data i.e. the rate at which the buffer is emptied. In the simplest case the transmission rate is simply set equal to the received decode rate, without any regard to the calculated maximum transmission rate previously discussed. In such a case the step 102 relating to the calculation of max_rate is not performed. By setting the transmission rate equal to the decode rate it can be ensured that the buffer will not overflow, as in theory data should arrive at the buffer at the same rate as it is removed therefrom. A steady transmission rate should then ensue, with variations in transmission rate being dependent upon variations in encoding rate.

The above first variation assumes, however, that transmission across the network is perfect, with no packet losses taking place en route. In a second variation, therefore, as well as receiving the decode rate from the client, the server also receives the loss_rate metric mentioned previously (the calculation of the loss_rate value is described in detail later), and factors this into its calculation of transmission rate as follows:
data_rate=(1+loss_rate)*decode_rate Eq. 3
In this manner, the server can make some advance compensation for the present loss rate being experienced in the network.

In another variation, the server receives information relating to how full the buffers are, and performs step or continuous changes in the transmission rate to prevent the buffers from overflowing. There are many possible algorithms which could be applied in this case, such as, for example, the data rate being inversely related to the percentage of filling of the buffers (i.e. the greater the percentage the lower the data rate), or by achieving step changes using thresholding techniques (e.g. in a simple case: If buffer<x% full then transmit at a first higher rate, else if buffer>x% full then transmit at a second lower rate. Algorithms with more than one threshold can equally be envisaged). Step changes in transmission rate can be achieved by controlling the encoding of the source data to give a higher (better quality) or lower (poorer quality) encoding rate.

In a fourth variation the value max_rate calculated at step 102 is used. Here, the server receives the decode rate information from the client, and the sending rate calculator 46 first checks to see if the received decode rate is less than the calculated max_rate. If so the transmission rate is set to be the same as the decode rate at the client, else the transmission rate is set to be the calculated maximum transmission rate. By taking into account the calculated maximum transmission rate as described above, it becomes possible to account for network congestion, as well as to render the data stream TCP-friendly.

It will no doubt be understood by the intended reader that other more complicated rate control algorithms could be used with the available information received from the client, and that the above examples are intended as non-limiting examples only. The essential aspects of the first embodiment of the present invention are, however, that feedback data of some sort which relates to the receiver buffers is sent to the server, and is used in the server to control its transmission rate to prevent the buffers at the client from overflowing. It will no doubt be apparent to the intended reader that other schemes other than those outlined above could also be used to achieve this purpose.

Returning to FIG. 6, after the calculation of the sending rates for each stream, at step S106 the network connection 47 in the server transmits the one or more streams as separate UDP data streams, at the calculated sending rates. It should be noted that as the one or more steams are continuously transmitted, the steps of FIG. 11, although depicted sequentially, are actually performed in parallel, such the transmission rates of the streams are in reality updated once new values for the transmission rates have been calculated. While the new calculations are being performed, however, the streams continue to be transmitted at the previously calculated rate.

At Step S108 of FIG. 6 the server computer 40 receives feedback data from the or each client computer 50, which in the first embodiment is that data which is required to perform the maximum transmission rate and data stream transmission rate calculations of steps S102 and S104. In particular for each stream the server receives data informing it of the round trip time presently being experienced at the client, the loss rate of packets at the client, the respective decoding rates of the buffers in the client, and the data receiving rate of each data stream at the client. These quantitative values are transmitted back to the server via the TCP connection from the or each client. It should be noted that these values are passed back from the or each client for each transmitted data stream.

Once updated feedback data has been received from the client, it is passed to the sending rate calculator 46 in the server, which performs the calculations in steps S102 and S104 once again, passing the results to the network connection 47, which transmits the streams with the new calculated sending rates. This process is continuous during the or each client session.

The calculation of the quantitative values passed back from the or each client computer to the server will now be discussed with respect to the operation of one of the client computers in the first embodiment as set out in FIG. 7. With reference to FIG. 7, at step S101 the network connection 57 in the client computer 50 receives the one or more data streams as individual UDP transmissions over the network. As described previously, the network connection 57 depacketises the encoded data from the respective UDP streams and passes the encoded data to the buffer controller 59, for buffering and subsequent decoding.

In the case of a single stream containing audio or video data, the encoded data received by the buffer controller 59 is stored respectively in one of the the audio buffer 54 or the video buffer 52. At step S103 the buffer controller 59 acts to interrogate the audio buffer 54 and the video buffer 52 respectively so as to determine the status of each buffer. In particular, the buffer controller determines information as to how full each buffer is, and how quickly the encoded audio and video information in each buffer is being decoded by the respective audio and video decoders 53 and 55. This is indicative of how quickly the audio and video buffers are being emptied by the respective decoders. Once the buffer controller has determined the each buffer's status the determined information is passed to the feedback transmitter 58 for encapsulation into a control message for transmission back to the server computer 40.

In addition to passing the encoded audio and video data to the buffer controller, the network connection 57 also passes information concerning the received data to the metrics calculator 56 in order to allow the metrics calculator 56 to calculate the quantitative metrics values that are passed back to the server by the feedback transmitter 58. Therefore, at steps S105, S107 and S109 the metrics calculator respectively calculates for each stream the round trip time (RTT), the loss event rate, and the received data rate per stream, all of which are required at the server as input into equations 1 and 2 for calculation of the maximum transmission rate available per data stream. It should be noted that the three metrics are calculated individually for each received data stream, such that a set of metrics is provided for each received data stream. Calculation of each of these quantitative values is discussed in turn next.

With respect to RTT, as mentioned previously RTT is a measure of the time it takes for a packet to travel from a computer, across a network to another computer, and back. RTT is therefore something measured within the metrics calculator 56 at the client computer, but in order to prevent oscillations is preferably calculated as follows:
RTT=0.2*RTTₛₐₘₚₗₑ+0.8*RTTₘₑₐₙ Equation 4

The value RTTₛₐₘₚₗₑ is the most recent measure of RTT measured by the metrics calculator, whereas the value RTTₘₑₐₙ is the mean value of all previous measures of RTT.

In step S107 the metrics calculator 56 calculates the loss event rate per stream experienced at the client computer. The calculation of the loss event rate is the most complicated calculation which the metrics calculator 56 has to perform, and is dependent upon the detection of lost packets in the UDP stream from the sequence numbers of arriving packets. This detection of lost packets is performed by the network connection based upon the detection of packet sequence number in the arriving packets, wherein an expected packet is defined as lost if at least three packets with a higher sequence number than the expected packet arrive at the receiver without the expected packet having arrived. Therefore, if a packet with sequence number 5 is expected, then in the case where the next packets to arrive are packet 6, packet 7, and then packet 5, packet 5 is not defined as lost. However, if the next three packets to arrive in order are packet 7, packet 8, and packet 6 then because each of the three arrived packets have a higher sequence number than the expected packet 5, packet 5 is defined as lost.

Having specified how a packet is defined as lost as above, the metrics calculator then defines a further occurrence known as a loss event. Within the preferred embodiment, a loss event is defined as the detection of the loss of one or more packets in any RTT measurement. Therefore, if in any particular RTT measurement the packets numbered 4, 6, 7, 9, 10, and 11 arrive, then although packets 5 and 8 have been lost there has only actually been one loss event within the particular RTT measured. This method accounts for multiple packets being lost within the network at the same time, without overly affecting the total loss event rate calculation.

Once a loss event has been detected as described above, at step S74 the metrics calculator 56 calculates the most recent loss interval, being the number of packets received between the presently detected loss event and the previously detected loss event. The metrics calculator stores the newly calculated loss interval as well as the n most recently calculated loss intervals for application in a weighted filter to give an average loss interval value. The average loss interval value is calculated as follows.

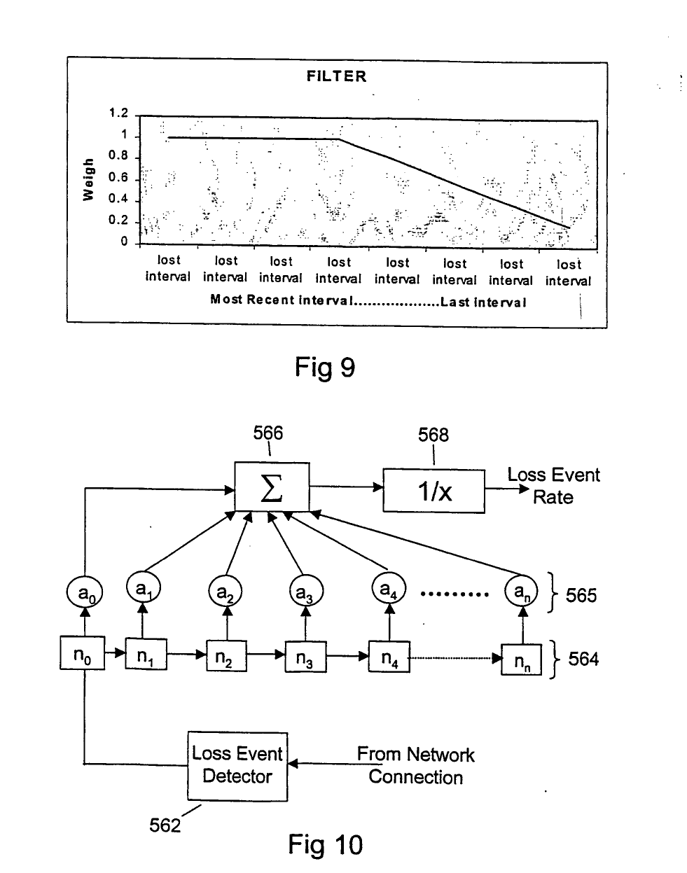

With reference to FIGS. 9 and 10, FIG. 10 illustrates some of the functional elements which make up the metrics calculator and which are used to calculate the loss rate. More particularly, the loss event detector 562 detects loss events as described previously, and outputs the most recently calculated loss interval to the first of a number of serially-connected loss interval buffers 564. When a new loss interval is input into the first series buffer 564 the previous loss interval value held in the first buffer is shifted along to the next buffer, whose value is shifted to the next buffer in the series, and so on, as shown in FIG. 10. In this way the n most recent loss interval values are stored for use in calculating the average loss interval value. Each loss interval value stored in the shift buffers 564 is respectively multiplied by a time-weighted loss interval co-efficient A0 to An, stored in respective co-efficient stores 656. The individual values A0 to An of the co-efficients are derived in accordance with a time weighted co-efficient function as shown in FIG. 9, which ensures that the most recent loss intervals count towards the calculation of the average loss interval to a greater extent than historic loss intervals which have been stored from previous calculations. The purpose of the application of this time weighted filter is to ensure that the calculated loss event rate changes smoothly.

The results of the weighted loss interval calculations are summed in a summer 566, the result of which is passed to an inverter 568 for the calculation of the loss rate, being the reciprocal of the average loss interval calculated by the summer 566. The thus calculated loss rate is then passed to the feedback transmitter 58 for transmission to the server computer as described previously.

Calculation of the received data rate is also performed by the metrics calculator 56, being a straightforward measure of the number of bits received by the client in a data stream in RTT seconds. Information concerning the amount of data being received at any one time in each stream is passed from the network connection 57 to the metrics calculator 56 for calculation of the receiving rate per stream. The calculated receiving rate per stream is then passed to the feedback transmitter 58 for transmission back to the server computer as described previously.

Once the feedback transmitter 58 has received the required information from the buffer controller 59 and the metrics calculator 56, it packetises the information into a form suitable for transmission over the network in the TCP connection 30.

It should be noted that the steps S101 to S1013 shown in the flow diagram of FIG. 7 are for illustrative purposes only, and that the or each client computer 50 can in fact perform any or all of these steps in any order desired. Furthermore, it is also possible to perform several of these steps in parallel, for instance the checking and measurement of the audio and video buffers performed by the buffer controller 59 can be performed in parallel with the calculations performed by the metrics calculator 56. Please note, however, that in the first embodiment it is necessary for the receiver to have actually received data in the audio and video data streams in order to have information necessary to calculate the quantitative values transmitted back to the server computer.

Within the server, the actual transmission rates of the or each stream is controlled by the network controller 48 and the network connection 47 in combination by actually releasing packets on to the network in accordance with the calculated rate. However, in the special case of the transmission of video data in the data stream, it may be that the calculated rate will not satisfy the transmission rate requirements for the particular encoding rate used. In this case, if it appears that the calculated transmission rate for the video stream has to drop such that at the present video encoding rate it will not be possible to transmit sufficient data in the video stream to prevent the video buffer at the receiver from emptying, then the network controller 48 controls the network connection 47 to take encoded video data from the low rate encoding video buffer 43 which has been encoded with a lower quality, which is more suitable for transmission across the network at the lower calculated transmission rate. At the receiver, the low rate encoded video data is placed in the video buffer and the video decoder 55 detects the lower rate of encoding and changes its own decoding rate to a lower rate, this reducing the rate at which video data is being read from the video buffer. Such measures prevent the video buffer from emptying completely, thereby permitting continuous video reproduction at the client computer.

Second Embodiment

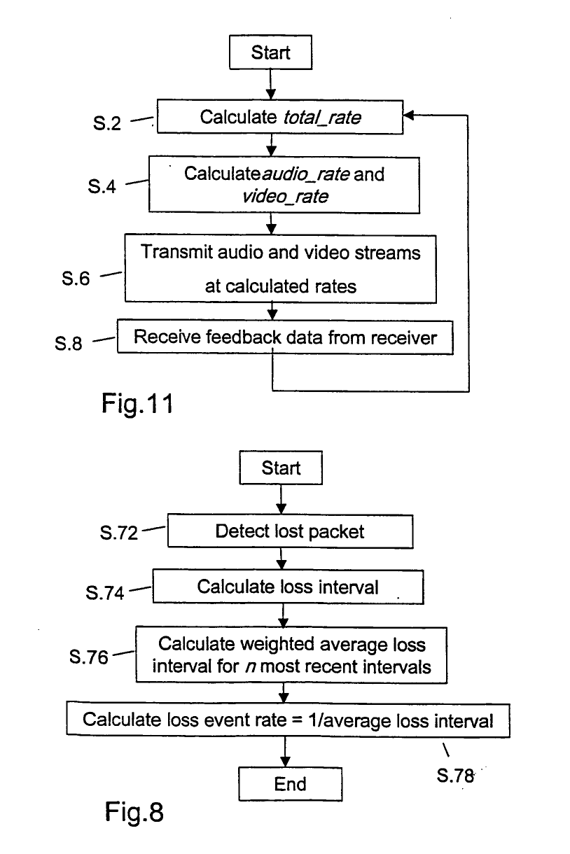

The operation of a second embodiment of the present invention will now be described with reference to FIGS. 8 to 13. The second embodiment of the invention is particularly concerned with sending more than one data stream to the same client, and in particular with sending simultaneous real-time audio and video data in separate audio and video data streams. Furthermore, as with the first embodiment the second embodiment is also concerned with controlling the transmission rate of the stream in a closed-loop manner

FIG. 11 is a flow diagram of the steps performed by the server computer 40 in accordance with the second embodiment of the present invention. Firstly, at step 2 the sending rate calculator 46 calculates the total bandwidth available for all of the individual data streams which are to be transmitted from the server computer 40. This value total_rate represents the upper limit on transmission rate which the individual transmission rates of each separate data stream when summed together should not be greater. The value total_rate is calculated in accordance with the following principles.

The same considerations for the calculation of the transmission rate of each stream apply in the second embodiment as in the first embodiment, and we therefore apply equations 1 and 2 as previously described in respect of the first embodiment separately to each stream to obtain a value max_rate for each stream, representing the maximum individual transmission rate for each of the audio and video data streams. However, in the present embodiment we are concerned with the transmission of multiple streams, and hence the above calculations must be performed separately for each stream to be transmitted. That is, both Equations 1 and 2 are applied in order to each stream (i.e. the audio and video streams in the second embodiment) and the value max_rate found for each stream. The respective values thus found for each stream are then summed together to give the value total_rate, being the total bandwidth available to all streams to provide for TCP-friendly performance, and thereby taking into account possible network congestion.

Following the calculation of the available total transmission rate, at step S4 the sending rate calculator 46 in the server calculates the individual transmission rates for each data stream, being in the second embodiment the transmission rate of the audio UDP stream (audio_rate) and the transmission rate of the video UDP stream (video_rate). The values of audio_rate and video_rate are calculated as follows.

As mentioned previously with respect to FIG. 3, the audio data is transmitted in a UDP stream separately from the video data which is transmitted in another UDP stream, and there are therefore two separate UDP connections one for each stream. Although it could be thought that each stream is competing for the same network bandwidth, in reality this is not true because it is not possible to send video and audio data packets at the same instant. Therefore, in the case of two data streams being audio and video streams, the previously calculated total sending bit rate can be made the equivalent of the audio sending bit rate plus the video sending bit rate. Furthermore, as will be described later, in the second embodiment the server is receiving information from the client about the state of the video and audio buffers, and the decoding rate for the video and audio packets. It therefore becomes possible to control the sending rates of the audio and video data streams to control the filling rate of the buffers in the client. This is achieved as follows.

Firstly, define parameters filling_rate_audio and filling_rate_video, being respectively the rates at which the audio and video buffers in the receiver fill with data. In the embodiment:
filling_rate_audio=audio_rate−decoding_audio_rate Eq.5
and
filling_rate_video=video_rate−decoding_video_rate Eq. 6
Assuming that control of the buffers in the receiver is required such that the buffers fill in the ratio x:y then:
x(filling_rate_audio)=y(filling_rate_video) Eq. 7
and
total_rate=audio_rate+video_rate Eq. 8
Performing appropriate substitutions and solving for audio_rate and video_rate respectively, then gives:

$$\begin{matrix}audio\_rate = \frac{\begin{matrix}y ( total\_rate \text{-} decoding\_video \_rate ) + \\ x ( decoding\_audio \_rate )\end{matrix}}{x + y} & Eq . 9 \\ video\_rate = \frac{\begin{matrix}x ( total\_rate \text{-} decoding\_audio \_rate ) + \\ y ( decoding\_video \_rate )\end{matrix}}{x + y} & Eq . 10\end{matrix}$$

Thus, as will be apparent from the above, it becomes possible to control the respective audio sending rates and video sending rates to trade bit rate from one stream to the other depending upon the respective audio and video decode rates in the receiver. Furthermore, it should be noted above that the parameter total_rate is the value calculated previously from the application of Equations 1 and 2 to give the total available bandwidth available for the transmission of all the data streams i.e. total_rate=total_rate_stream_{—}1+total_rate_stream_{—}2+ . . . +total_rate_stream_n wherein n is the number of data streams being transmitted simultaneously.

Returning to FIG. 11, after the calculation of the audio and video sending rates for each stream, at step S6 the network connection 47 in the server transmits the audio and video streams as separate UDP data streams, at the calculated audio and video sending rates. It should be noted that as the audio and video steams are continuously transmitted, the steps of FIG. 11, although depicted sequentially, are actually performed in parallel, such the transmission rates of the audio and video streams are in reality updated once new values for the audio and video transmission rates have been calculated. While the new calculations are being performed, however, these streams continue to be transmitted at the previously calculated rate.

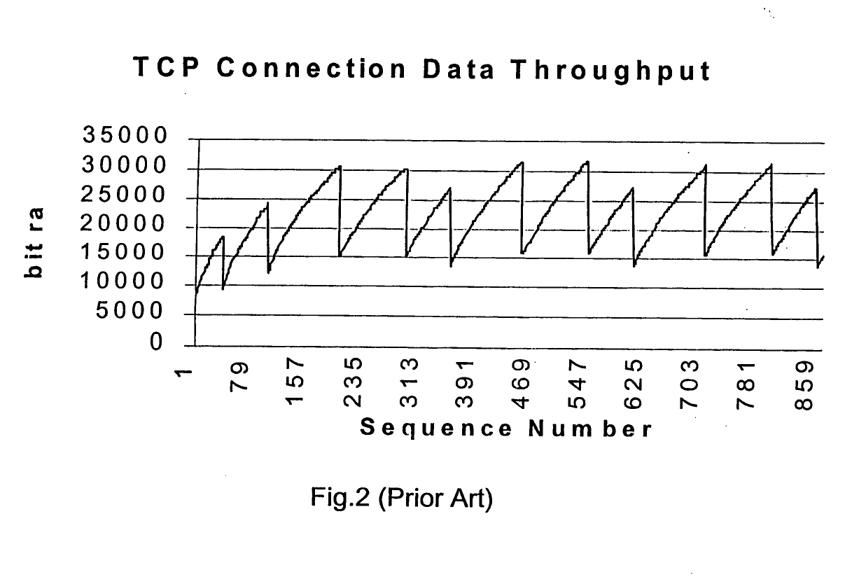

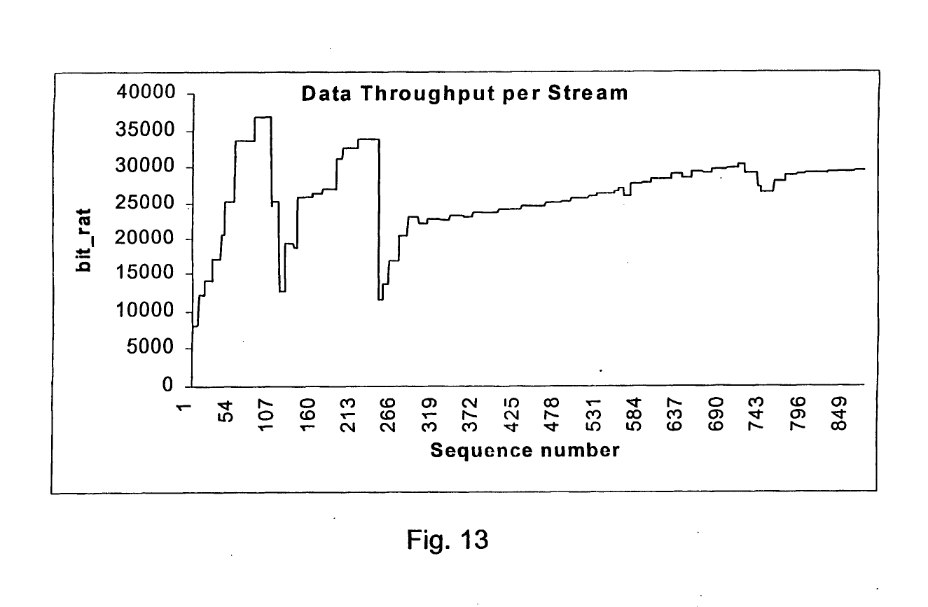

FIG. 13 shows a plot of the measured transmission rate of one data stream controlled in accordance with the embodiments of the present invention, when transmitting the same data as that transmitted by the TCP connection plotted in FIG. 2. From FIG. 13 it will be seen that after initial transient variations experienced at the opening of the session, the transmission rate of the stream steadies out, and continues with relatively little variance over time. Furthermore, when compared to the transmission rate experienced by the TCP connection shown in FIG. 2 it will be seen that an almost identical average throughput is achieved as TCP, but without the large changes in transmission rate which result from TCP's multiplicative decrease control algorithm. This property of providing a smooth transmission rate with respect to time renders the present invention particularly suitable for use in transmitting data which requires continuous streaming.

At Step S8 of FIG. 11 the server computer 40 receives feedback data from the client computer 50, which in the preferred embodiment is that data which is required to perform the total transmission rate and data stream transmission rate calculations of steps S2 and S4. In particular for each stream the server receives data informing it of the round trip time presently being experienced at the client, the loss rate of packets at the client, the respective decoding rates of the audio and video buffers in the client, and the data receiving rate of each data stream at the client. These quantitative values are transmitted back to the server via the TCP connection from the client.

Once updated feedback data has been received from the client, it is passed to the sending rate calculator 46 in the server, which performs the calculations in steps S2 and S4 once again, passing the results to the network connection 47, which transmits the audio and video streams with the new calculated sending rates. This process is continuous during the client session.

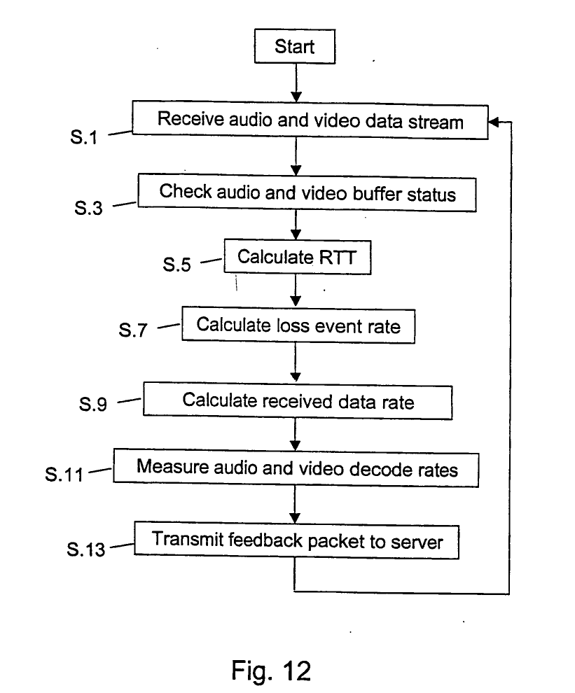

The calculation of the quantitative values passed back from the client computer to the server will now be discussed with respect to the operation of the client computer in the second embodiment as set out in FIG. 12. With reference to FIG. 12, at step S1 the network connection 57 in the client computer 50 receives the separate audio and video data streams as individual UDP transmissions over the network. As described previously, the network connection 57 depacketises the encoded audio and video data from the respective UDP streams and passes the encoded video and audio data to the buffer controller 59, for buffering and subsequent decoding.

The encoded audio and video received by the buffer controller 59 is stored respectively in the audio buffer 54 and video buffer 52. At step S3 the buffer controller 59 acts to interrogate the audio buffer 54 and the video buffer 52 respectively so as to determine the status of each buffer. In particular, the buffer controller determines information as to how full each buffer is, and how quickly the encoded audio and video information in each buffer is being decoded by the respective audio and video decoders 53 and 55. This is indicative of how quickly the audio and video buffers are being emptied by the respective decoders. Once the buffer controller has determined the audio and video buffer status the determined information is passed to the feedback transmitter 58 for encapsulation into a control message for transmission back to the server computer 40.

In addition to passing the encoded audio and video data to the buffer controller, the network connection 57 also passes information concerning the received data to the metrics calculator 56 in order to allow the metrics calculator 56 to calculate the quantitative metrics values that are passed back to the server by the feedback transmitter 58. Therefore, at steps S5, S7 and S9 the metrics calculator respectively calculates for each stream the round trip time (RTT), the loss event rate, and the received data rate per stream, all of which are required at the server as input into equations 1 and 2 for calculation of the transmission rate available per data stream. It should be noted that the three metrics are calculated individually for each received data stream, such that a set of metrics is provided for each received data stream. The calculation of each of these metrics for each stream is exactly the same as described previously in the first embodiment, and is therefore not repeated here.

Once the feedback transmitter 58 has received the required information from the buffer controller 59 and the metrics calculator 56, it packetises the information into a form suitable for transmission over the network in the TCP connection 30.

It should be noted that the steps S1 to S13 shown in the flow diagram of FIG. 12 are for illustrative purposes only, and that the client computer 50 can in fact perform any or all of these steps in any order desired. Furthermore, it is also possible to perform several of these steps in parallel, for instance the checking and measurement of the audio and video buffers performed by the buffer controller 59 can be performed in parallel with the calculations performed by the metrics calculator 56. Please note, however, that in the second embodiment it is necessary for the receiver to have actually received data in the audio and video data streams in order to have information necessary to calculate the quantitative values transmitted back to the server computer.

Within the server, the actual transmission rates of each stream are controlled by the network controller 48 and the network connection 47 in combination by actually releasing packets on to the network in accordance with the calculated rates. However, in the special case of the transmission of audio and video data described in the second embodiment, as in the first embodiment it may be that for the video data in particular the calculated rate will not satisfy the transmission rate requirements for the particular encoding rate used. In this case, if it appears that the calculated transmission rate for the video stream has to drop such that at the present video encoding rate it will not be possible to transmit sufficient data in the video stream to prevent the video buffer at the receiver from emptying, then the network controller 48 controls the network connection 47 to take encoded video data from the low rate encoding video buffer 43 which has been encoded with a lower quality, which is more suitable for transmission across the network at the lower calculated transmission rate. At the receiver, the low rate encoded video data is placed in the video buffer and the video decoder 55 detects the lower rate of encoding and changes its own decoding rate to a lower rate, this reducing the rate at which video data is being read from the video buffer. Such measures prevent the video buffer from emptying completely, thereby permitting continuous video reproduction at the client computer.

It should be noted that because the second embodiment of the invention is directed towards sending audio and video data as the multiple data streams, then within the second embodiment the criteria for setting the respective bit-rates of each stream are chosen to reflect the special requirements of audio and video data in that it has to be decoded at a receiver to reproduce the original audio and video signal. However, the present invention is not to be limited to the transmission of audio and video data as the multiple data streams and in fact almost any type of data which requires sending in one or more streams can be transmitted using the present invention.

Furthermore, with respect to the calculation of the total maximum transmission bandwidth available used in the present invention, within the preferred embodiments we used a transmission rate formula which is intended to simulate the average throughput obtained by a standard TCP connection. However, it should be understood that neither the particular formula nor the reason for using that formula are intended to be limitations on the present invention, and that in fact any suitable transmission rate formula can be used to calculate the maximum transmission rate available which is then used to calculate the individual stream transmission rates.

More particularly and as an example, where transmission is to be undertaken over an Internet protocol network then other transmission rate formulas which provide for a TCP-friendly transmission rate can be used in place of the formula used in this specific embodiment, and various other TCP-friendly formulas are presently known in the art. Furthermore, where different formulas requiring different parameters as input are used, then the or each client computer should be arranged to calculate and supply whatever parameters are required by the server. In the case where an IP network is not used, then the transmission rate formula chosen should preferably be one which is meaningful to whatever transport protocols are used on the particular network of interest, and which preferably provides for meaningful transmission rate control to take into account such factors as network congestion and resulting packet loss or the like. In other embodiments of the invention it should be apparent to the skilled man what transmission rate formulas are appropriate, depending upon the particular field of application of the invention.

Third Embodiment

A third embodiment of the present invention will now be described. The third embodiment is particularly concerned with sending one or more independent streams to the same or different clients, and controlling the transmission rate of the or each stream in an open-loop manner.

The previously described embodiments related to closed-loop control systems, wherein information received from the client was used at the server to control the transmission rate. Within the third embodiment, however, open-loop control is performed, by virtue of the server keeping track of the packets that it has sent to the client in the or each data stream, and making an estimate of how much space is left in the client's buffer using a priori knowledge of the client buffer size (S) in bytes, the amount of static buffering the client would undertake before starting to read the received data from the buffer, and the rate at which data would be read from the buffer. The server can then keep a constantly updated estimate of how much space the client has left in its buffer, and control the transmission rate accordingly.

More particularly, within the third embodiment the sending rate calculator 46 as stored therein information relating to the following properties of the or each client:
a) how much static buffering the client will do before decoding starts (T seconds); and
b) how big, in bytes, the client's buffer is (S bytes).

In addition, the network connection 47 in the server monitors and passes information to the sending rate calculator relating to the following:
c) the raw decode rate of the data that is being transmitted at a particular time t (d(t) bytes/sec); and
d) the transmission rate of the data at that time t (tx(t) bytes/sec).

The network connection calculates the decode rate at the client by logging each packet that is transmitted to the client. As each packet has a timestamp on, and the network connection in the server also knows how long each packet is, it is then able to calculate the piecewise bytes-per-second that the client should consume the received packets from it's buffer. The transmission rate will of course be known by the network connection, and can simply be logged against time to keep a record thereof. The network connection passes information relating to the decode-rate and the past transmission rate to the sending rate calculator.

Having determined and received the above variables, the sending rate calculator can then determine the amount of space (space) in bytes left in the buffers at any time t by applying the following equation:

$$space = S - {\int }_{0}^{t} t x ( t ) ⅆ t for t < T \\ space = S - {\int }_{0}^{t} t x ( t ) ⅆ t - {\int }_{t}^{τ} ⅆ ( t ) ⅆ t for t < T \qquad Equation 11$$

Using the above equation, no feedback is necessary from the client about buffer fullness or the received data decode rate (the read rate from the receiver's buffer), but it is required that the server knows the values of T (the static buffering time—how much time the client spends buffering data when it firsts receives a stream before it starts reading data from the buffer) and S (the size of the client's buffer in bytes) in advance. However, by continuously performing the above calculation it is possible for the server to maintain an estimate at all times during the stream transmission of the amount of space left in the client's buffer, for as long as the client does what the server thinks it will do (i.e. won't start decoding until T seconds from the start, and has a buffer size S). Of course, the client would have to signal if something else happened (i.e. the user pressed pause) so that the server could re-calculate. Such signalling could be over a TCP channel as described previously in respect of the first and second embodiments. In addition, if any packet loss occurs and the client signals it back, then the fullness of the buffer can be adjusted by the size of that packet.

Of course, when T & S are not known, or are dynamic, then feedback of the current buffer fullness will be required, as described in the first embodiment previously.

When the server is transmitting multiple streams, the above processing steps are performed for each stream to determine the remaining space in each respective buffer for each stream.

The above method determines an estimate space in bytes of how much space the server believes the client has left in its buffer at any particular time during the transmission. It is then necessary to use this information to actually control the transmission rate of the or each stream to prevent the buffer from overflowing. Within the third embodiment, as with the first embodiment, this can be achieved in a number of ways.

In a first variation the server may use the space information to perform step or continuous changes in the transmission rate to prevent the buffers from overflowing. There are many possible algorithms which could be applied in this case, such as, for example, the data rate being inversely related to the percentage of filling of the buffers (i.e. the greater the percentage the lower the data rate), or by achieving step changes using thresholding techniques (e.g. in a simple case: If buffer<x% full then transmit at a first higher rate, else if buffer>x% full then transmit at a second lower rate. Algorithms with more than one threshold can equally be envisaged). Step changes in transmission rate can be achieved by controlling the encoding of the source data to give a higher (better quality) or lower (poorer quality) encoding rate.

In another variation the server could transmit at a rate as fast as possible given the present network conditions in order to fill the client's buffer (as estimated by the server), and then stop transmitting until the buffer is emptied to a certain level (again as estimated by the server). In this variation the data would be transmitted as a series of streams in a burst-type manner, and would not achieve the steady-state transmission that is usually advantageous for streaming multimedia, but such a ‘bursty’ type transmission may have merit in some possible network environments.

It will no doubt be understood by the intended reader that other more complicated rate control algorithms could be used with the space information determined by the server, and that the above examples are intended as non-limiting examples only. The essential aspects of the third embodiment of the present invention are, however, that the remaining space in the receiver buffers is estimated at the server, and is used in the server to control its transmission rate to prevent the buffers at the client from overflowing. It will no doubt be apparent to the intended reader that other schemes other than those outlined above could also be used to achieve this purpose.

It should also be noted that within the third embodiment it is also possible to calculate a maximum transmission rate, and apply the calculated maximum rate to the transmission rate control as an upper bound. The calculation of the maximum transmission rate would be the same as previously described in respect of the first and second embodiments. Its application to the rate control algorithm could also be similar, in that the calculated maximum rate is simply applied to whatever rate control algorithm is chosen as a maximum upper bound above which the transmission rate should not pass. Alternatively, in a further variation where multiple streams are transmitted to the same client, the transmission rate control may be as described in the second embodiment, with the difference that the values of decode rate as monitored at the server rather than as communicated back from the receiver are used in the rate control equations.

1. A method of data transmission across a network, comprising the steps of:
transmitting data onto the network for transmission to a receiver in the form of a data stream at a data transmission rate;
determining at least one or more characteristics of a data buffer in the receiver in which the received data is stored; and
controlling the data transmission rate of the data stream in response to the determined one or more characteristics in order to prevent the data buffer in the receiver from overflowing.

2. A method according to claim 1, wherein the determining step further comprises the steps of: monitoring the amount of data already transmitted to the receiver in the data stream; storing one or more parameters relating to the receiver buffer; and estimating the one or more characteristics on the basis of the monitored data and the stored parameters; wherein the estimating step is performed in an open-loop manner without repeated feedback from the receiver indicative of the one or more characteristics of the receiver data buffer.

3. A method according to claim 1, wherein the determining step further comprises the steps of:
receiving feedback data from the receiver indicative of the one or more characteristics of the receiver data buffer;
wherein the controlling step controls the data transmission rate in response to the received feedback data.

4. A method according to claim 1, wherein the one or more characteristics include at least the decoding rate of the transmitted data in the stream received at the receiver; and the transmission rate of the data stream is further controlled as a function of at least the receiver decoding rate.

5. A method according to claim 1, wherein the one or more characteristics include information indicative of the remaining capacity of the buffer.

6. A method according to claim 1, and further comprising calculating a maximum transmission rate at which the data stream should be transmitted, the controlling step being further arranged to control the transmission bit-rate so as to be within the calculated maximum bit-rate.

7. A method according to claim 6 wherein the maximum transmission rate is calculated to give an average thoughput of data over the network similar to that obtained using Transport Control Protocol (TCP).

8. A method according to claim 6, wherein the calculating step further comprises the steps of:
receiving feedback data from the receiver indicative of one or more of a round trip time value (RTT), a loss rate value, and/or a receiving rate value at the receiver; and
calculating the maximum transmission rate as a function of one or more of the received values indicated by the feedback data;
wherein the round trip time is a measure of the time it takes for data to travel from a transmitter to the receiver and back to the transmitter; the loss rate value is a measure of the amount of data transmitted to the receiver which is lost; and the receiving rate value is the number of bits received in the round trip-time.

9. A method according to claim 8, wherein the maximum transmission rate is calculated In accordance with:
$$bit\_rate \_per \_stream = c ( \frac{data\_medium \_size}{{t}_{R T T} \sqrt{{loss}_{rate}}} )$$
wherein:
maximum_rate_stream=min(bit_rate_per_stream, 2xReceiving_Rate)
wherein data_medium_size is a measure of the average size of the data sent across the network in the stream, and c is a constant in the range 0.87≦c≦1.31.

10. A method according to claim 1, and further comprising the steps of transmitting a plurality of data streams onto the network for transmission to one or more receivers, each at a respective data transmission rate; determining for each stream at least the one or more characteristics of respective data buffers in which the received data In each stream is stored; and controlling the respective data transmission rates of each stream in response to the received feedback data in order to prevent the data buffers from overflowing.

11. A method according to claim 10 and further comprising calculating a maximum transmission rate at which the data stream should be transmitted, the controlling step being further arranged to control the transmission bit-rate so as to be within the calculated maximum bit-rate, wherein for two streams transmitted to the same receiver, the respective data transmission rates for each stream are controlled in accordance with the following equations:
$$sr\_str \_ 1 = \frac{y ( t r - dr\_str2 ) + x ( dr\_str1 )}{x + y}$$
$$sr\_str \_ 2 = \frac{x ( t r - dr\_str1 ) + y ( dr\_str2 )}{x + y}$$
wherein the variables relate to the following:
Sr_str_1: sending rate of the first data stream;
Sr_str_2: sending rate of the second data stream:
tr: the sum of the calculated maximum transmission rates for each stream;
dr_str1: the decoding rate at the receiver of the data in the first data stream;
dr_str2: the decoding rate at the receiver of the data in the second data stream;
x: a co-efficient of filling rate of a first buffer in the receiver which receives data from the first data stream; and
y: a co-efficient of filling rate of a second buffer in the receiver which receives data from the second data stream.

12. A method of generating one or more data streams on a network comprising a method of data transmission according to claim 1.

13. A system for data transmission across a network, comprising:
data stream transmission means for transmitting data onto the network for transmission to a receiver in a data stream at a data transmission bit rate;
characteristic determination means for determining at least one or more characteristics of a data buffer in the receiver in which the received data is stored; and
data stream controlling means for controlling the data transmission rate of the data stream in response to the determined characteristics in order to prevent the data buffer in the receiver from overflowing.

14. A system according to claim 13, wherein the characteristic determination means further comprise: monitoring means for monitoring the amount of data already transmitted to the receiver in the data stream; storage means for storing one or more parameters relating to the receiver buffer; and estimating means for estimating the one or more characteristics on the basis of the monitored data and the stored parameters; wherein the estimating means is operable to perform the estimate in an open-loop manner without repeated feedback from the receiver indicative of the one or more characteristics of the receiver data buffer.

15. A system according to claim 13, wherein the characteristic determination means further comprise:
data receiving means for receiving feedback data from the receiver indicative of the one or more characteristics of the receiver data buffer;
wherein the data stream controlling means is further operable to control the data transmission rate in response to the received feedback data.

16. A system according to claim 13, wherein the one or more characteristics include at least the decoding rate of the transmitted data in the stream received at the receiver; and the data stream controlling means is further operable to control the transmission rate of the data stream as a function of at least the receiver decoding rate.

17. A system according to claim 13, wherein the one or more characteristics include information indicative of the remaining capacity of the buffer.

18. A system according to claim 13, and further comprising calculation means for calculating a maximum transmission rate at which the data stream should be transmitted, the data stream controlling means being further operable to control the transmission bit-rate so as to be within the calculated maximum bit-rate.

19. A system according to claim 18 wherein the calculation means is further operable to calculate the maximum transmission rate to give an average thoughput of data over the network similar to that obtained using Transport Control Protocol (TCP).

20. A system according to claim 18, wherein the data receiving means is further arranged to receive feedback data from the receiver indicative of one or more of a round trip time value (RTT), a loss rate value, and/or a receiving rate value at the receiver; and the calculation means is d=further arranged to calculate the maximum transmission rate as a function of one or more of the received values indicated by the feedback data;
wherein the round trip time is a measure of the time it takes for data to travel from a transmitter to the receiver and back to the transmitter; the loss rate value is a measure of the amount of data transmitted to the receiver which is lost; and the receiving rate value is the number of bits received in the round trip-time.

21. A system according to claim 20, wherein the maximum transmission rate is calculated in accordance with:
$$bit\_rate \_per \_stream = c ( \frac{data\_medium \_size}{{t}_{R T T} \sqrt{{loss}_{rate}}} )$$
wherein:
maximum_rate_stream=min(bit_rate_per_stream, 2xReceiving_Rate)
wherein data_medium_size is a measure of the average size of the data sent across the network in the stream, and c is a constant in the range 0.87≦C≦1.31.

22. A system according to claim 13, comprising means for transmitting a plurality of data streams onto the network for transmission to one or more receivers, each at a respective data transmission rate; means for determining for each stream at least the one or more characteristics of respective data buffers in which the received data in each stream is stored; and means for controlling the respective data transmission rates of each stream in response to the received feedback data in order to prevent the data buffers from overflowing.

23. A system according to claim 22 and further comprising calculation means for calculating a maximum transmission rate at which the data stream should be transmitted, the data stream controlling means being further operable to control the transmission bit-rate so as to be within the calculated maximum bit-rate,
wherein for two streams transmitted to the same receiver, the respective data transmission rates for each stream are controlled in accordance with the following equations:
$$sr\_str \_ 1 = \frac{y ( t r - dr\_str2 ) + x ( dr\_str1 )}{x + y}$$
$$sr\_str \_ 2 = \frac{x ( t r - dr\_str1 ) + y ( dr\_str2 )}{x + y}$$
wherein the variables relate to the following:
Sr_str_1: sending rate of the first data stream;
Sr_str_2: sending rate of the second data stream:
tr: the sum of the calculated maximum transmission rates for each stream;
dr_str1: the decoding rate at the receiver of the data in the first data stream;
dr_str2: the decoding rate at the receiver of the data in the second data stream;
x: a co-efficient of filling rate of a first buffer in the receiver which receives data from the first data stream; and
y: a co-efficient of filling rate of a second buffer in the receiver which receives data from the second data stream.

24. A computer readable storage medium storing a computer program which when run on a computer controls the computer to perform a method according to claim 1.

25. A method of receiving data from a network, the data having been transmitted according to a transmission method as claimed in claim 3, the method comprising the steps of:
receiving a data stream at a data transmission rate;
passing the received data to a data buffer for buffering therein;
measuring at least one or more characteristics of the data buffer; and
transmitting the measured characteristics to a transmitter for use in calculating the transmission rate for the data stream transmitted therefrom.

26. A method according to claim 25, further comprising the step of:
decoding the data in the buffer at a decoding rate;
wherein the data decoding rate is transmitted to the transmitter as at least one of the measured characteristics.

27. A method according to claim 25, wherein the one or more characteristics Include information indicative of the remaining capacity of the buffer.

28. A method according to claim 25, and further comprising calculating one or more of a round trip time value (RTT), a loss rate value, and/or a receiving rate value, and transmitting the calculated values back to the transmitter; wherein the round trip time is a measure of the time it takes for data to travel from a transmitter to a receiver and back to the transmitter; the loss rate value is a measure of the amount of data transmitted to a receiver which is lost; and the receiving rate value is the number of bits received by the receiver in the round trip time.

29. A method according to claim 28, wherein the loss rate is calculated using a weighted filter of the n most recent loss intervals, being the output of data received between two loss events.

30. A system for receiving data from a network, the data having been transmitted according to a transmission method as claimed in claim 3, the method comprising the steps of:
data receiving means for receiving a data stream at a data transmission rate;
data bus means for passing the received data to a data buffer for buffering therein;
buffer monitoring means for measuring at least one or more characteristics of the data buffer; and
data transmission means for transmitting the measured characteristics to a transmitter for use in calculating the transmission rate for the data stream transmitted therefrom.

31. A system according to claim 30, further comprising:
decoding means for decoding the data in the buffer at a decoding rate;
wherein the data decoding rate is transmitted to the transmitter as at least one of the measured characteristics.

32. A system according to claim 30, wherein the one or more characteristics include information indicative of the remaining capacity of the buffer.

33. A system according to claim 30, and further comprising calculating means for calculating one or more of a round trip time value (RTT), a loss rate value, and/or a receiving rate value; the data transmission means being further operable to transmit the calculated values back to the transmitter; wherein the round trip time is a measure of the time it takes for data to travel from a transmitter to a receiver and back to the transmitter; the loss rate value is a measure of the amount of data transmitted to a receiver which is lost; and the receiving rate value is the number of bits received by the receiver In the round trip time.

34. A system according to claim 33, wherein the loss rate is calculated using a weighted filter of the n most recent loss intervals, being the output of data received between two loss events.

35. A computer-readable storage medium storing a computer program which when run on a computer controls the computer to perform the method of claim 25.

36. A method of data transmission across a network, comprising the steps of:
calculating a total transmission rate for the transmission of data using a transmission rate formula;
transmitting data onto the network for transmission to a receiver in at least two separate data streams each at a respective data transmission bit rate; and
controlling the respective data transmission rates of at least a subset of the respective data streams to trade bit-rate between said streams;
wherein the sum of the respective transmission rates of each data stream is substantially equal to or less than the calculated total transmission rate.

37. A method according to claim 36, wherein the data transmission rates of the data streams are controlled so as to prevent data buffers in the receiver which receive the data in the data streams from overflowing.

38. A method according to claim 36 wherein the controlling steps further comprises the step of receiving feedback data from the receiver; and
controlling the data transmission rates of at least a subset of the respective data streams in response to the received data.

39. A method according to claim 38 wherein the received feedback data is indicative of at least the decoding rate of the transmitted data in each stream received at the receiver; and the transmission rates of the controlled data streams are further controlled as a function of at least the receiver decoding rates.

40. A method according to claim 39 wherein in the case of two data streams the respective transmission rates are controlled in accordance with the equations:
$$sr\_str \_ 1 = \frac{y ( t r - dr\_str2 ) + x ( dr\_str1 )}{x + y}$$
$$sr\_str \_ 2 = \frac{x ( t r - dr\_str1 ) + y ( dr\_str2 )}{x + y}$$
wherein the variables relate to the following:
Sr_str_1: sending rate of the first data stream;
Sr_str_2: sending rate of the second data stream:
tr: the calculated total transmission rate;
dr_str1: the decoding rate at the receiver of the data in the first data stream;
dr_str2: the decoding rate at the receiver of the data in the second data stream;
x: a co-efficient of filling rate of a first buffer in the receiver which receives data from the first data stream; and
y: a co-efficient of filling rate of a second buffer in the receiver which receives data from the second data stream.

41. A method according to claim 36 wherein the total transmission rate is calculated to give an average thoughput of data over the network similar to that obtained using Transport Control Protocol (TCP).

42. A method according to claim 36 wherein the calculating step further comprises the steps of:
receiving feedback data from the receiver indicative of one or more of a round trip time value (RTT), a loss rate value, and/or a receiving rate value at the receiver; and
calculating the total transmission rate as a function of one or more of the received values indicated by the feedback data;
wherein the round trip time is a measure of the time it takes for data to travel from a transmitter to the receiver and back to the transmitter; the loss rate value is a measure of the amount of data transmitted to the receiver which is lost; and the receiving rate value is the number of bits received in the round trip-time.

43. A method according to claim 42, wherein the total transmission rate is calculated in accordance with:
$$bit\_rate \_per \_stream = c ( \frac{data\_medium \_size}{{t}_{R T T} \sqrt{{loss}_{rate}}} )$$
wherein:
total_rate_stream_x=min(bit_rate_per_stream_x, 2xReceiving_Rate_x)
and:
total_rate=total_rate_stream_{—}1+total_rate_stream_{—}2+ . . . +total_rate_stream_n
wherein x ε {1, 2, . . . n}, data_medium_size is a measure of the average size of the data sent across the network per stream, c is a constant in the range 0.87≦c≦1.31, and n is the number of data streams to be transmitted.

44. A method according to claim 36, wherein the data transmitted in at least a subset of two or more of the data streams is related.

45. A method according to claim 44, wherein at least one of said data streams contains real-time data of a first type, and one or more other of said data streams contains real-time data of a second type related to said data of said first type.

46. A method of generating a plurality of data streams on a network comprising a method of data transmission according to claim 36.

47. A system for data transmission across a network, comprising:
transmission rate calculation means for calculating a total transmission rate for the transmission of data using a transmission rate formula;
data stream transmission means for transmitting data onto the network for transmission to a receiver in at least two separate data streams each at a respective data transmission bit rate; and
data stream controlling means for controlling the respective data transmission rates of at least a subset of the respective data streams to trade bit-rate between said streams;
wherein the data stream controlling means is further operable such that the sum of the respective transmission rates of each data stream is controlled to be substantially equal to or less than the calculated total transmission rate.

48. A system according to claim 47, wherein the data stream controlling means is further arranged to control the data transmission rates of the data streams so as to prevent data buffers in the receiver which receives the data in the data streams from overflowing.

49. A system according to claim 47 further comprising data receiving means for receiving feedback data from the receiver; wherein the data stream controlling means is further arranged to control the data transmission rates of at least a subset of the respective data streams in response to the received data.

50. A system according to claim 49 wherein the received feedback data is indicative of at least the decoding rate of the transmitted data in each stream received at the receiver; and the data stream controlling means is further arranged to control the transmission rates of the controlled data streams as a function of at least the receiver decoding rates.

51. A system according to claim 50 wherein in the case of two data streams the respective transmission rates are controlled in accordance with the equations:
$$sr\_str \_ 1 = \frac{y ( t r - dr\_str2 ) + x ( dr\_str1 )}{x + y}$$
$$sr\_str \_ 2 = \frac{x ( t r - dr\_str1 ) + y ( dr\_str2 )}{x + y}$$
wherein the variables relate to the following:
Sr_str_1: Sending rate of the first data stream;
Sr_str_2: sending rate of the second date stream:
tr: the calculated total transmission rate;
dr_str1: the decoding rate at the receiver of the data in the first data stream;
dr_str2: the decoding rate at the receiver of the data in the second data stream;
x: a co-efficient of filling rate of a first buffer in the receiver which receives data from the first data stream; and
y: a co-efficient of filling rate of a second buffer in the receiver which receives data from the second data stream.

52. A system according to claim 47 wherein the total transmission rate is calculated to give an average thoughput of data over the network similar to that obtained using Transport Control Protocol (TCP).

53. A system according to claim 47 further comprising:
data receiving means for receiving feedback data from the receiver indicative of one or more of a round trip time value (RTT), a loss rate value, and/or a receiving rate value at the receiver; and wherein the transmission rate calculation means is further arranged to calculate the total transmission rate as a function of one or more of the received values indicated by the feedback data;
wherein the round trip time is a measure of the time it takes for data to travel from a transmitter to the receiver and back to the transmitter; the loss rate value is a measure of the amount of data transmitted to the receiver which is lost; and the receiving rate value is the number of bits received in the round trip-time.

54. A system according to claim 53 wherein the total transmission rate is calculated in accordance with:
$$bit\_rate \_per \_stream \_x = c ( \frac{data\_medium \_size}{{t}_{RTT} \sqrt{{loss}_{rate}}} )$$
wherein:
total_rate_stream_x=min(bit_rate_per_stream_x, 2xReceiving_Rate_x)
and:
total_rate=total_rate_stream_{—}1+total_rate_stream_{—}2+ . . . +total_rate_stream_n
wherein x ε {1, 2, . . . n}, data_medium_size is a measure of the average size of the data sent across the network, c is a constant in the range 0.87≦c≦1.31, and n is the number of data streams to be transmitted.

55. A system according to claim 47 wherein the data transmitted in at least two or more of the data streams is related.

56. A system according to claim 55, wherein at least one of said data streams contains real-time data of a first type and one or more other of said data streams contains real-time data of a second type related to said data of said first type.

57. A computer readable storage medium storing a computer program which when run on a computer controls the computer to perform a method according to claim 36.

58. A method of receiving data from a network, the data having been transmitted according to a transmission method as claimed in claim 36 the method comprising the steps of:
receiving at least two separate data streams each at a respective data transmission rate;
passing the received data in each stream to a respective data buffer for buffering therein;
calculating one or more quantitative values indicative of one or more characteristics of the received data; and
transmitting the calculated quantitative values to a transmitter for use in calculating the total transmission rate for data transmitted therefrom.

59. A method according to claim 58, further comprising the step of:
decoding the data in each buffer at a respective decoding rate;
wherein the respective data decoding rates are transmitted to the transmitter as at least one of the calculated quantitative values.

60. A method according to claim 58 wherein the calculating step further comprises calculating one or more of a round trip time value (RTT), a loss rate value, and/or a receiving rate value as the one or more quantitative values, wherein the round trip time is a measure of the time it takes for data to travel from a transmitter to a receiver and back to the transmitter; the loss rate value is a measure of the amount of data transmitted to a receiver which is lost; and the receiving rate value is the number of bits received by the receiver in the round trip time.

61. A method according to claim 60, wherein the loss event rate is calculated using a weighted filter of the n most recent loss intervals, being the output of data received between two loss events.

62. A system for receiving data from a network, the data having been transmitted according to a transmission method as claimed in claim 36, the system comprising:
data receiving means for receiving at least two separate data streams each at a respective data transmission rate;
at least two data buffers arranged to receive data therein from the respective received data streams;
calculation means for calculating one or more quantitative values indicative of one or more characteristics of the received data; and
data transmission means for transmitting the calculated quantitative values to a transmitter for use in calculating the total transmission rate for data transmitted therefrom.

63. A system according to claim 62, further comprising data decoding means for decoding the data in each buffer at a respective decoding rate;
wherein the respective data decoding rates are transmitted to the transmitter as at least one of the calculated quantitative values.

64. A system according to claim 62 wherein the calculation means are further operable to calculate one or more of a round trip time value (RTT), a loss rate value, and/or a receiving rate value as the one or more quantitative values, wherein the round trip time is a measure of the time it takes for data to travel from a transmitter to a receiver and back to the transmitter; the loss rate is a measure of the amount of data transmitted to a receiver which is lost; and the receiving rate value is the number of bits received by the receiver in the round-trip-time.

65. A system according to claim 64 wherein the calculation means further comprises a weighted filter means for calculating the loss event rate using a weighted filter of the n most recent loss intervals, being the amount of data received between two loss events.

66. A computer-readable storage medium storing a computer program which when run on a computer controls the computer to perform the method of claim 58.
